(19) United States
(12) Patent Application Publication
(10) Pub. No.: US 2006/0257560 A1
(43) Pub. Date: Nov. 16, 2006

(54) Polymer surfaces for insitu synthesis of polymer arrays

(75) Inventors: Anthony D. Barone, San Jose, CA (US); Handong Li, San Jose, CA (US); Glenn H. McGall, Palo Alto, CA (US)

Correspondence Address: AFFYMETRIX, INC;ATTN: CHIEF IP COUNSEL, LEGAL DEPT., 3420 CENTRAL EXPRESSWAY, SANTA CLARA, CA, 95051, US

(73) Assignee: Affymetrix, INC., Santa Clara, CA (US)

(21) Appl. No.: 11/317,509

(22) Filed: Jul. 13, 2006

Related U.S. Application Data
(60) Provisional application No. 60/640,419, filed on Dec. 30, 2004.

(51) Int. Cl. C08F 2/46; B05D 3/12; B05D 1/18

(52) U.S. Cl. 427/240; 427/430.1; 427/487

(57) ABSTRACT

In one aspect of the present invention polymers are used to create films providing three-dimensional array substrates. The films were stable and presented good hydroxyl group numbers as compared with arrays without polymer films. It is an object of the present invention that three dimensional arrays substrates provide a means to obtain higher density polymer arrays.

### FIELD OF THE INVENTION

The present invention relates generally to materials and methods to fabricate high density arrays. More specifically, the present invention, relates to three dimensional polymer coating for enhancing the number of available hydroxyl groups in a particular area (hydroxyl groups provide the situs for attaching polymer probes).

### BACKGROUND OF THE INVENTION

Nucleic acid arrays, and in particular very high density nucleic acid arrays have greatly transformed laboratory research that utilizes molecular biology and recombinant DNA techniques and has also impacted the fields of diagnostics, forensics, nucleic acid analysis and gene expression monitoring, to name a few. There remains a need in the art for methods and techniques for making even higher density arrays.

### SUMMARY OF THE INVENTION

According to one aspect of the present invention, methods are presented for preparing 3 dimensional arrays. According to one aspect of the present invention, polymers are used to coat glass wafers to create a film of varying thickness. The film renders the polymer more “three dimensional” than the glass plate with oligonucleotide directly attached thereto. It was observed that the films of an aspect of the instant invention provided a substantial number of hydroxyl groups which can be used to link or fabricate probes in a variety of ways.

### BRIEF DESCRIPTION OF THE FIGURES

FIG. 1 depicts thickness of formulation as a function of spin speed and duration.

FIG. 2 depicts the hydroxyl density of various films.

FIG. 3 shows fluorescence scan images of photolithographically-patterned stripes on a hydrogel coated glass slide.

FIG. 4 depicts a confocal scan image of a checkerboard pattern resulting from hybridization of a fluorescein-labeled 20-mer oligonucleotide complimentary to the probe synthesis area.

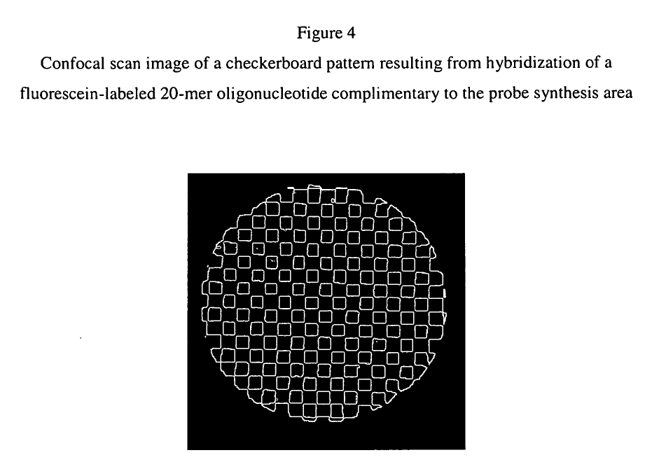

FIG. 5 depicts site density and t6-mer relative yield data on thiol-derivatized surfaces coated with hydrogels.

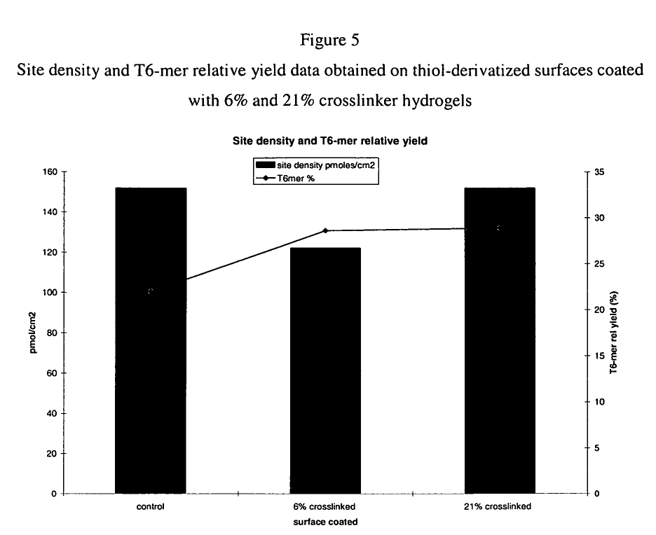

### DETAILED DESCRIPTION OF THE INVENTION

A. General

The present invention has many preferred embodiments and relies on many patents, applications and other references for details known to those of the art. Therefore, when a patent, application, or other reference is cited or repeated below, it should be understood that it is incorporated by reference in its entirety for all purposes as well as for the proposition that is recited.

As used in this application, the singular form “a,” “an,” and “the” include plural references unless the context clearly dictates otherwise. For example, the term “an agent” includes a plurality of agents, including mixtures thereof.

An individual is not limited to a human being but may also be other organisms including but not limited to mammals, plants, bacteria, or cells derived from any of the above.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995) Biochemistry (4th Ed.) Freeman, N.Y., Gait, “Oligonucleotide Synthesis: A Practical Approach” 1984, IRL Press, London, Nelson and Cox (2000), Lehninger, Principles of Biochemistry 3^{rd} Ed., W.H. Freeman Pub., New York, N.Y. and Berg et al. (2002) Biochemistry, 5^{th} Ed., W.H. Freeman Pub., New York, N.Y., all of which are herein incorporated in their entirety by reference for all purposes.

The present invention can employ solid substrates, including arrays in some preferred embodiments. Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, in PCT Applications Nos. PCT/US99/00730 (International Publication No. WO 99/36760) and PCT/US01/04285 (International Publication No. WO 01/58593), which are all incorporated herein by reference in their entirety for all purposes.

Patents that describe synthesis techniques in specific embodiments include U.S. Pat. Nos. 5,412,087, 6,147,205, 6,262,216, 6,310,189, 5,889,165, and 5,959,098. Nucleic acid arrays are described in many of the above patents, but the same techniques are applied to polypeptide arrays.

Nucleic acid arrays that are useful in the present invention include those that are commercially available from Affymetrix (Santa Clara, Calif.) under the brand name GeneChip®. Example arrays are shown on the website at affymetrix.com.

The present invention also contemplates many uses for polymers attached to solid substrates. These uses include gene expression monitoring, profiling, library screening, genotyping and diagnostics. Gene expression monitoring and profiling methods can be shown in U.S. Pat. Nos. 5,800,992, 6,013,449, 6,020,135, 6,033,860, 6,040,138, 6,177,248 and 6,309,822. Genotyping and uses therefore are shown in U.S. Ser. Nos. 10/442,021, 10/013,598 (U.S. Patent Application Publication 20030036069), and U.S. Pat. Nos. 5,856,092, 6,300,063, 5,858,659, 6,284,460, 6,361,947, 6,368,799 and 6,333,179. Other uses are embodied in U.S. Pat. Nos. 5,871,928, 5,902,723, 6,045,996, 5,541,061, and 6,197,506.

The present invention also contemplates sample preparation methods in certain preferred embodiments. Prior to or concurrent with genotyping, the genomic sample may be amplified by a variety of mechanisms, some of which may employ PCR. See, for example, PCR Technology: Principles and Applications for DNA Amplification (Ed. H. A. Erlich, Freeman Press, NY, N.Y., 1992); PCR Protocols: A Guide to Methods and Applications (Eds. Innis, et al., Academic Press, San Diego, Calif., 1990); Mattila et al., Nucleic Acids Res. 19, 4967 (1991); Eckert et al., PCR Methods and Applications 1, 17 (1991); PCR (Eds. McPherson et al., IRL Press, Oxford); and U.S. Pat. Nos. 4,683,202, 4,683,195, 4,800,159 4,965,188,and 5,333,675, and each of which is incorporated herein by reference in their entireties for all purposes. The sample may be amplified on the array. See, for example, U.S. Pat. No. 6,300,070 and U.S. Ser. No. 09/513,300, which are incorporated herein by reference.

Other suitable amplification methods include the ligase chain reaction (LCR) (for example, Wu and Wallace, Genomics 4, 560 (1989), Landegren et al., Science 241, 1077 (1988) and Barringer et al. Gene 89:117 (1990)), transcription amplification (Kwoh et al., Proc. Natl. Acad. Sci. USA 86, 1173 (1989) and W088/10315), self-sustained sequence replication (Guatelli et al., Proc. Nat. Acad. Sci. USA, 87, 1874 (1990) and WO90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5, 413,909, 5,861,245) and nucleic acid based sequence amplification (NABSA). (See, U.S. Pat. Nos. 5,409,818, 5,554,517, and 6,063,603, each of which is incorporated herein by reference). Other amplification methods that may be used are described in, U.S. Pat. Nos. 5,242,794, 5,494,810, 4,988,617 and in U.S. Ser. No. 09/854,317, each of which is incorporated herein by reference.

Additional methods of sample preparation and techniques for reducing the complexity of a nucleic sample are described in Dong et al., Genome Research 11, 1418 (2001), in U.S. Pat. No. 6,361,947, 6,391,592 and U.S. Ser. Nos. 09/916,135, 09/920,491 (U.S. Patent Application Publication 20030096235), Ser. No. 09/910,292 (U.S. Patent Application Publication 20030082543), and Ser. No. 10/013,598.

Methods for conducting polynucleotide hybridization assays have been well developed in the art. Hybridization assay procedures and conditions will vary depending on the application and are selected in accordance with the general binding methods known including those referred to in: Maniatis et al. Molecular Cloning: A Laboratory Manual (2^{nd} Ed. Cold Spring Harbor, N.Y., 1989); Berger and Kimmel Methods in Enzymology, Vol. 152, Guide to Molecular Cloning Techniques (Academic Press, Inc., San Diego, Calif., 1987); Young and Davism, P.N.A.S, 80: 1194 (1983). Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference.

The present invention also contemplates signal detection of hybridization between ligands in certain preferred embodiments. See U.S. Pat. Nos. 5,143,854, 5,578,832; 5,631,734; 5,834,758; 5,936,324; 5,981,956; 6,025,601; 6,141,096; 6,185,030; 6,201,639; 6,218,803; and 6,225,625, in U.S. Ser. No. 10/389,194 and in PCT Application PCT/US99/06097 (published as WO99/47964), each of which also is hereby incorporated by reference in its entirety for all purposes.

Methods and apparatus for signal detection and processing of intensity data are disclosed in, for example, U.S. Pat. Nos. 5,143,854, 5,547,839, 5,578,832, 5,631,734, 5,800,992, 5,834,758; 5,856,092, 5,902,723, 5,936,324, 5,981,956, 6,025,601, 6,090,555, 6,141,096, 6,185,030, 6,201,639; 6,218,803; and 6,225,625, in U.S. Ser. Nos. 10/389,194, 60/493,495 and in PCT Application PCT/US99/06097 (published as WO99/47964), each of which also is hereby incorporated by reference in its entirety for all purposes.

The practice of the present invention may also employ conventional biology methods, software and systems. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes and etc. The computer executable instructions may be written in a suitable computer language or combination of several languages. Basic computational biology methods are described in, for example Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis Bioinformatics: A Practical Guide for Analysis of Gene and Proteins (Wiley & Sons, Inc., 2^{nd} ed., 2001). See U.S. Pat. No. 6,420,108.

The present invention may also make use of various computer program products and software for a variety of purposes, such as probe design, management of data, analysis, and instrument operation. See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170.

Additionally, the present invention may have preferred embodiments that include methods for providing genetic information over networks such as the Internet as shown in U.S. Ser. Nos. 10/197,621, 10/063,559 (United States Publication No. 20020183936), Ser. Nos. 10/065,856, 10/065,868, 10/328,818, 10/328,872, 10/423,403, and 60/482,389.

B. Definitions

The term “array” as used herein refers to an intentionally created collection of molecules which can be prepared either synthetically or biosynthetically. The molecules in the array can be identical or different from each other. The array can assume a variety of formats,for example, libraries of soluble molecules; libraries of compounds tethered to resin beads, silica chips, or other solid supports.

The term “monomer” as used herein refers to a single unit of polymer, which can be linked with the same or other monomers to form a biopolymer (for example, a single amino acid or nucleotide with two linking groups one or both of which may have removable protecting groups) or a single unit which is not part of a biopolymer. Thus, for example, a nucleotide is a monomer within an oligonucleotide polymer, and an amino acid is a monomer within a protein or peptide polymer; antibodies, antibody fragments, chromosomes, plasmids, mRNA, cRNA, TRNA etc., for example, are also polymers.

The term “biopolymer” or sometimes refer by “biological polymer” as used herein is intended to mean repeating units of biological or chemical moieties. Representative biopolymers include, but are not limited to, nucleic acids, oligonucleotides, amino acids, proteins, peptides, hormones, oligosaccharides, lipids, glycolipids, lipopolysaccharides, phospholipids, synthetic analogues of the foregoing, including, but not limited to, inverted nucleotides, peptide nucleic acids, Meta-DNA, and combinations of the above. It is important to note that biopolymers and polymers are not mutually exclusive. Proteins, enzymes, DNA, polyethylene, RNA, are all polymers as they are derived from a repeating monomer unit. However, proteins, enzymes, DNA are all biopolymers as many of them first appeared in nature. Sometimes, it is not easy to classify something as a biopolymer or a polymer. For example, vast number of human made amino acid derivatives and nucleotide derivatives have been created and polymerized. Some of these are based on natural products, many more are not. At this point the distinction between the two can be somewhat semantical.

The term “biopolymer synthesis” as used herein is intended to encompass the synthetic production, both in situ (in the cell) and synthetically, e.g. by organic synthetic techniques outside of the cell, of a biopolymer. Related to a bioploymer is a “biomonomer”.

The term “combinatorial synthesis strategy” as used herein refers to a combinatorial synthesis strategy which is an ordered strategy for parallel synthesis of diverse polymer sequences by sequential addition of reagents which may be represented by a reactant matrix and a switch matrix, the product of which is a product matrix. A reactant matrix of L column(s) by M row(s) of the building blocks to be added. The switch matrix is all or a subset of the binary numbers, preferably ordered, between l and m arranged in columns. A “binary strategy” is one in which at least two successive steps illuminate a portion, often half, of a region of interest on the substrate. In a binary synthesis strategy, all possible compounds which can be formed from an ordered set of reactants are formed. In most preferred embodiments, binary synthesis refers to a synthesis strategy which also factors a previous addition step. For example, a strategy in which a switch matrix for a masking strategy halves regions that were previously illuminated, illuminating about half of the previously illuminated region and protecting the remaining half (while also protecting about half of previously protected regions and illuminating about half of previously protected regions). It will be recognized that binary rounds may be interspersed with non-binary rounds and that only a portion of a substrate may be subjected to a binary scheme. A combinatorial “masking” strategy is a synthesis which uses light or other spatially selective deprotecting or activating agents to remove protecting groups from materials for addition of other materials such as amino acids.

The term “complementary” as used herein refers to the hybridization or base pairing between nucleotides or nucleic acids, such as, for instance, between the two strands of a double stranded DNA molecule or between an oligonucleotide primer and a primer binding site on a single stranded nucleic acid to be sequenced or amplified. Complementary nucleotides are, generally, A and T (or A and U), or C and G. Two single stranded RNA or DNA molecules are said to be complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, complementarity exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See, M. Kanehisa Nucleic Acids Res. 12:203 (1984), incorporated herein by reference.

The term “copolymer” refers to a polymer that is composed of more than one monomer. Copolymers may be prepared by polymerizing one or more monomers to provide a copolymer.

The term “detectable moiety” (Q) means a chemical group that provides a signal. The signal is detectable by any suitable means, including spectroscopic, photochemical, biochemical, immunochemical, electrical, optical or chemical means. In certain cases, the signal is detectable by 2 or more means.

The detectable moiety provides the signal either directly or indirectly. A direct signal is produced where the labeling group spontaneously emits a signal, or generates a signal upon the introduction of a suitable stimulus. Radiolabels, such as ³H, ¹²⁵I, ³⁵S, ¹⁴C or ³²P, and magnetic particles, such as Dynabeads™, are nonlimiting examples of groups that directly and spontaneously provide a signal. Labeling groups that directly provide a signal in the presence of a stimulus include the following nonlimiting examples: colloidal gold (40-80 nm diameter), which scatters green light with high efficiency; fluorescent labels, such as fluorescein, Texas red, Rhoda mine, and green fluorescent protein (Molecular Probes, Eugene, Oreg.), which absorb and subsequently emit light; chemiluminescent or bioluminescent labels, such as luminol, lophine, acridine salts and luciferins, which are electronically excited as the result of a chemical or biological reaction and subsequently emit light; spin labels, such as vanadium, copper, iron, manganese and nitroxide free radicals, which are detected by electron spin resonance (ESR) spectroscopy; dyes, such as quinoline dyes, triarylmethane dyes and acridine dyes, which absorb specific wavelengths of light; and colored glass or plastic (e.g., polystyrene, polypropylene, latex, etc.) beads. See U.S. Pat. Nos. 3,817,837; 3,850,752; 3,939,350; 3,996,345; 4,277,437; 4,275,149 and 4,366,241.

A detectable moiety provides an indirect signal where it interacts with a second compound that spontaneously emits a signal, or generates a signal upon the introduction of a suitable stimulus. Biotin, for example, produces a signal by forming a conjugate with streptavidin, which is then detected. See Hybridization With Nucleic Acid Probes. In Laboratory Techniques in Biochemistry and Molecular Biology; Tijssen, P., Ed.; Elsevier: N.Y., 1993; Vol. 24. An enzyme, such as horseradish peroxidase or alkaline phosphatase, that is attached to an antibody in a label-antibody-antibody complex, as in an ELISA assay, also produces an indirect signal.

A preferred detectable moiety is a fluorescent group. Fluorescent groups typically produce a high signal to noise ratio, thereby providing increased resolution and sensitivity in a detection procedure. Preferably, the fluorescent group absorbs light with a wavelength above about 300 nm, more preferably above about 350 nm, and most preferably above about 400 nm. The wavelength of the light emitted by the fluorescent group is preferably above about 310 nm, more preferably above about 360 nm, and most preferably above about 410 nm.

The fluorescent detectable moiety is selected from a variety of structural classes, including the following nonlimiting examples: 1- and 2-aminonaphthalene, p,p′diaminostilbenes, pyrenes, quaternary phenanthridine salts, 9-aminoacridines, p,p′diaminobenzophenone imines, anthracenes, oxacarbocyanine, marocyanine, 3-aminoequilenin, perylene, bisbenzoxazole, bis-p-oxazolyl benzene, 1,2-benzophenazin, retinol, bis-3-aminopridinium salts, hellebrigenin, tetracycline, sterophenol, benzimidazolyl phenylamine, 2-oxo-3-chromen, indole, xanthen, 7-hydroxycoumarin, phenoxazine, salicylate, strophanthidin, porphyrins, triarylmethanes, flavin, xanthene dyes (e.g., fluorescein and rhodamine dyes); cyanine dyes; 4,4-difluoro-4-bora-3a,4a-diaza-s-indacene dyes and fluorescent proteins (e.g., green fluorescent protein, phycobiliprotein).

A number of fluorescent compounds are suitable for incorporation into the present invention. Nonlimiting examples of such compounds include the following: dansyl chloride; fluoresceins, such as 3,6-dihydroxy-9-phenylxanthhydrol; rhodamineisothiocyanate; N-phenyl-1-amino-8-sulfonatonaphthalene; N-phenyl-2-amino-6-sulfonatonaphthanlene; 4-acetamido-4-isothiocyanatostilbene-2,2′-disulfonic acid; pyrene-3-sulfonic acid; 2-toluidinonapththalene-6-sulfonate; N-phenyl, N-methyl 2-aminonaphthalene-6-sulfonate; ethidium bromide; stebrine; auromine-0,2-(9′-anthroyl)palmitate; dansyl phosphatidylethanolamin; N,N′-dioctadecyl oxacarbocycanine; N,N′-dihexyl oxacarbocyanine; merocyanine, 4-(3′-pyrenyl)butryate; d-3-aminodesoxy-equilenin; 12-(9′-anthroyl)stearate; 2-methylanthracene; 9-vinylanthracene; 2,2′-(vinylene-p-phenylene)bisbenzoxazole; p-bis[2-(4-methyl-5-phenyl oxazolyl)]benzene; 6-dimethylamino-1,2-benzophenzin; retinol; bis(3′-aminopyridinium)-1,10-decandiyl diiodide; sulfonaphthylhydrazone of hellibrienin; chlorotetracycline; N-(7-dimethylamino-4-methyl-2-oxo-3-chromenyl)maleimide; N-[p-(2-benzimidazolyl)phenyl]maleimide; N-(4-fluoranthyl)maleimide; bis(homovanillic acid); resazarin; 4-chloro-7-nitro-2,1,3-benzooxadizole; merocyanine 540; resorufin; rose bengal and 2,4-diphenyl-3(2H)-furanone. Preferably, the fluorescent detectable moiety is a fluorescein or rhodamine dye.

Another preferred detectable moiety is colloidal gold. The colloidal gold particle is typically 40 to 80 nm in diameter. The colloidal gold may be attached to a labeling compound in a variety of ways. In one embodiment, the linker moiety of the nucleic acid labeling compound terminates in a thiol group (—SH), and the thiol group is directly bound to colloidal gold through a dative bond. See Mirkin et al. Nature 1996, 382, 607-609. In another embodiment, it is attached indirectly, for instance through the interaction between colloidal gold conjugates of antibiotin and a biotinylated labeling compound. The detection of the gold labeled compound may be enhanced through the use of a silver enhancement method. See Danscher et al. J. Histotech 1993, 16, 201-207.

The term “effective amount” as used herein refers to an amount sufficient to induce a desired result.

Although generally used herein to define separate regions containing differing polymer sequences, the term “feature” generally refers to any element, e.g., region, structure or the like, on the surface of a substrate. Typically, substrates to be scanned, will have small feature sizes, and consequently, high feature densities on substrate surfaces. For example, individual features will typically have at least one of a length or width dimension that is no greater than 100 microns, and preferably, no greater than 50 microns, and more preferably no greater than about 20 microns. Thus, for embodiments employing substrates having a plurality of polymer sequences on their surfaces, each different polymer sequence will typically be substantially contained within a single feature.

The term “fragmentation” refers to the breaking of nucleic acid molecules into smaller nucleic acid fragments. In certain embodiments, the size of the fragments generated during fragmentation can be controlled such that the size of fragments is distributed about a certain predetermined nucleic acid length.

The term “genome” as used herein is all the genetic material in the chromosomes of an organism. DNA derived from the genetic material in the chromosomes of a particular organism is genomic DNA. A genomic library is a collection of clones made from a set of randomly generated overlapping DNA fragments representing the entire genome of an organism.

The term “hybridization” as used herein refers to the process in which two single-stranded polynucleotides bind non-covalently to form a stable double-stranded polynucleotide; triple-stranded hybridization is also theoretically possible. The resulting (usually) double-stranded polynucleotide is a “hybrid.” The proportion of the population of polynucleotides that forms stable hybrids is referred to herein as the “degree of hybridization.” Hybridizations are usually performed under stringent conditions, for example, at a salt concentration of no more than 1 M and a temperature of at least 25° C. For example, conditions of 5×SSPE (750 mM NaCl, 50 mM NaPhosphate, 5 mM EDTA, pH 7.4) and a temperature of 25-30° C. are suitable for allele-specific probe hybridizations. For stringent conditions, see, for example, Sambrook, Fritsche and Maniatis. “Molecular Cloning A laboratory Manual” 2^{nd} Ed. Cold Spring Harbor Press (1989) which is hereby incorporated by reference in its entirety for all purposes above.

The term “hybridization conditions” as used herein will typically include salt concentrations of less than about IM, more usually less than about 500 mM and preferably less than about 200 mM. Hybridization temperatures can be as low as 5° C., but are typically greater than 22° C., more typically greater than about 30° C., and preferably in excess of about 37° C. Longer fragments may require higher hybridization temperatures for specific hybridization. As other factors may affect the stringency of hybridization, including base composition and length of the complementary strands, presence of organic solvents and extent of base mismatching, the combination of parameters is more important than the absolute measure of any one alone.

The term “hybridization probes” as used herein are oligonucleotides capable of binding in a base-specific manner to a complementary strand of nucleic acid. Such probes include peptide nucleic acids, as described in Nielsen et al., Science 254, 1497-1500 (1991), and other nucleic acid analogs and nucleic acid mimetics.

The term “hybridizing specifically to” as used herein refers to the binding, duplexing, or hybridizing of a molecule only to a particular nucleotide sequence or sequences under stringent conditions when that sequence is present in a complex mixture (for example, total cellular) DNA or RNA.

The term “initiation monomer” or “initiator monomer” as used herein is meant to indicate the first monomer which is covalently attached via reactive groups, e.g., nucleophiles and electrophiles to the surface of the polymer, or the first monomer which is attached to a linker or spacer arm attached to the polymer, the linker or spacer arm being attached to the polymer via reactive groups.

The term “isolated nucleic acid” as used herein mean an object species invention that is the predominant species present (i.e., on a molar basis it is more abundant than any other individual species in the composition). Preferably, an isolated nucleic acid comprises at least about 50, 80 or 90% (on a molar basis) of all macromolecular species present. Most preferably, the object species is purified to essential homogeneity (contaminant species cannot be detected in the composition by conventional detection methods).

The term “ligand” as used herein refers to a molecule that is recognized by a particular receptor. The agent bound by or reacting with a receptor is called a “ligand,” a term which is definitionally meaningful only in terms of its counterpart receptor. The term “ligand” does not imply any particular molecular size or other structural or compositional feature other than that the substance in question is capable of binding or otherwise interacting with the receptor. Also, a ligand may serve either as the natural ligand to which the receptor binds, or as a functional analogue that may act as an agonist or antagonist. Examples of ligands that can be investigated by this invention include, but are not restricted to, agonists and antagonists for cell membrane receptors, toxins and venoms, viral epitopes, hormones (for example, opiates, steroids, etc.), hormone receptors, peptides, enzymes, enzyme substrates, substrate analogs, transition state analogs, cofactors, drugs, proteins, and antibodies.

The term “linkage disequilibrium” or sometimes refer by allelic association as used herein refers to the preferential association of a particular allele or genetic marker with a specific allele, or genetic marker at a nearby chromosomal location more frequently than expected by chance for any particular allele frequency in the population. For example, if locus X has alleles a and b, which occur equally frequently, and linked locus Y has alleles c and d, which occur equally frequently, one would expect the combination ac to occur with a frequency of 0.25. If ac occurs more frequently, then alleles a and c are in linkage disequilibrium. Linkage disequilibrium may result from natural selection of certain combination of alleles or because an allele has been introduced into a population too recently to have reached equilibrium with linked alleles.

The term “mixed population” or sometimes refer by “complex population” as used herein refers to any sample containing both desired and undesired nucleic acids. As a non-limiting example, a complex population of nucleic acids may be total genomic DNA, total genomic RNA or a combination thereof. Moreover, a complex population of nucleic acids may have been enriched for a given population but includes other undesirable populations. For example, a complex population of nucleic acids may be a sample which has been enriched for desired messenger RNA (mRNA) sequences but still includes some undesired ribosomal RNA sequences (rRNA).

The term “monomer” as used herein refers to any member of the set of molecules that can be joined together to form an oligomer or polymer. The set of monomers useful in the present invention includes, but is not restricted to, for example, those for polypeptide synthesis, including the set of L-amino acids, D-amino acids, and/or synthetic amino acids. As used herein, “monomer” refers to any member of a basis set for synthesis of an oligomer. For example, dimers of L-amino acids form a basis set of 400 “monomers” for synthesis of polypeptides. Different basis sets of monomers may be used at successive steps in the synthesis of a polymer. The term “monomer” also refers to a chemical subunit that can be combined with a different chemical subunit to form a compound larger than either subunit alone.

The term “mRNA,” or sometimes referred to as “mRNA transcripts,” as used herein, includes, but not limited to pre-mRNA transcript(s), transcript processing intermediates, mature mRNA(s) ready for translation and transcripts of the gene or genes, or nucleic acids derived from the mRNA transcript(s). Transcript processing may include splicing, editing and degradation. As used herein, a nucleic acid derived from an mRNA transcript refers to a nucleic acid for whose synthesis the mRNA transcript or a subsequence thereof has ultimately served as a template. Thus, a cDNA reverse transcribed from an mRNA, an RNA transcribed from that cDNA, a DNA amplified from the cDNA, an RNA transcribed from the amplified DNA, etc., are all derived from the mRNA transcript and detection of such derived products is indicative of the presence and/or abundance of the original transcript in a sample. Thus, mRNA derived samples include, but are not limited to, mRNA transcripts of the gene or genes, cDNA reverse transcribed from the mRNA, cRNA transcribed from the cDNA, DNA amplified from the genes, RNA transcribed from amplified DNA, and the like.

The term “nucleic acid library” or sometimes refer by “array” as used herein refers to an intentionally created collection of nucleic acids which can be prepared either synthetically or biosynthetically and screened for biological activity in a variety of different formats (for example, libraries of soluble molecules; and libraries of oligos tethered to resin beads, silica chips, or other solid supports). Additionally, the term “array” is meant to include those libraries of nucleic acids which can be prepared by spotting nucleic acids of essentially any length (for example, from 1 to about 1000 nucleotide monomers in length) onto a substrate. The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleotide sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

The term “nucleic acids” as used herein may include any polymer or oligomer of pyrimidine and purine bases, preferably cytosine, thymine, and uracil, and adenine and guanine, respectively. See Albert L. Lehninger, PRINCIPLES OF BIOCHEMISTRY, at 793-800 (Worth Pub. 1982). Indeed, the present invention contemplates any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states.

The term “PVP” refers to polyvinylpyrrolidone, which has the structure:

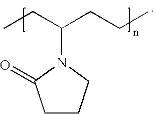

The term “oligonucleotide” or sometimes refer by “polynucleotide” as used herein refers to a nucleic acid ranging from at least 2, preferable at least 8, and more preferably at least 20 nucleotides in length or a compound that specifically hybridizes to a polynucleotide. Polynucleotides of the present invention include sequences of deoxyribonucleic acid (DNA) or ribonucleic acid (RNA) which may be isolated from natural sources, recombinantly produced or artificially synthesized and mimetics thereof. A further example of a polynucleotide of the present invention may be peptide nucleic acid (PNA). The invention also encompasses situations in which there is a nontraditional base pairing such as Hoogsteen base pairing which has been identified in certain tRNA molecules and postulated to exist in a triple helix. “Polynucleotide” and “oligonucleotide” are used interchangeably in this application.

The term “polymorphism” as used herein refers to the occurrence of two or more genetically determined alternative sequences or alleles in a population. A polymorphic marker or site is the locus at which divergence occurs. Preferred markers have at least two alleles, each occurring at frequency of greater than 1%, and more preferably greater than 10% or 20% of a selected population. A polymorphism may comprise one or more base changes, an insertion, a repeat, or a deletion. A polymorphic locus may be as small as one base pair. Polymorphic markers include restriction fragment length polymorphisms, variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wild type form. Diploid organisms may be homozygous or heterozygous for allelic forms. A diallelic polymorphism has two forms. A triallelic polymorphism has three forms. Single nucleotide polymorphisms (SNPs) are included in polymorphisms.

The term “primer” as used herein refers to a single-stranded oligonucleotide capable of acting as a point of initiation for template-directed DNA synthesis under suitable conditions for example, buffer and temperature, in the presence of four different nucleoside triphosphates and an agent for polymerization, such as, for example, DNA or RNA polymerase or reverse transcriptase. The length of the primer, in any given case, depends on, for example, the intended use of the primer, and generally ranges from 15 to 30 nucleotides. Short primer molecules generally require cooler temperatures to form sufficiently stable hybrid complexes with the template. A primer need not reflect the exact sequence of the template but must be sufficiently complementary to hybridize with such template. The primer site is the area of the template to which a primer hybridizes. The primer pair is a set of primers including a 5′ upstream primer that hybridizes with the 5′ end of the sequence to be amplified and a 3′ downstream primer that hybridizes with the complement of the 3′ end of the sequence to be amplified.

The term “probe” as used herein refers to a surface-immobilized molecule that can be recognized by a particular target. See U.S. Pat. No. 6,582,908 for an example of arrays having all possible combinations of probes with 10, 12, and more bases. Examples of probes that can be investigated by this invention include, but are not restricted to, agonists and antagonists for cell membrane receptors, toxins and venoms, viral epitopes, hormones (for example, opioid peptides, steroids, etc.), hormone receptors, peptides, enzymes, enzyme substrates, cofactors, drugs, lectins, sugars, oligonucleotides, nucleic acids, oligosaccharides, proteins, and monoclonal antibodies.

The term “receptor” as used herein refers to a molecule that has an affinity for a given ligand. Receptors may be naturally-occurring or manmade molecules. Also, they can be employed in their unaltered state or as aggregates with other species. Receptors may be attached, covalently or noncovalently, to a binding member, either directly or via a specific binding substance. Examples of receptors which can be employed by this invention include, but are not restricted to, antibodies, cell membrane receptors, monoclonal antibodies and antisera reactive with specific antigenic determinants (such as on viruses, cells or other materials), drugs, polynucleotides, nucleic acids, peptides, cofactors, lectins, sugars, polysaccharides, cells, cellular membranes, and organelles. Receptors are sometimes referred to in the art as anti-ligands. As the term receptors is used herein, no difference in meaning is intended. A “Ligand Receptor Pair” is formed when two macromolecules have combined through molecular recognition to form a complex. Other examples of receptors which can be investigated by this invention include but are not restricted to those molecules shown in U.S. Pat. No. 5,143,854, which is hereby incorporated by reference in its entirety.

The term “solid support”, “support”, and “substrate” as used herein are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. See U.S. Pat. No. 5,744,305 for exemplary substrates.

The term “target” as used herein refers to a molecule that has an affinity for a given probe. Targets may be naturally-occurring or man-made molecules. Also, they can be employed in their unaltered state or as aggregates with other species. Targets may be attached, covalently or noncovalently, to a binding member, either directly or via a specific binding substance. Examples of targets which can be employed by this invention include, but are not restricted to, antibodies, cell membrane receptors, monoclonal antibodies and antisera reactive with specific antigenic determinants (such as on viruses, cells or other materials), drugs, oligonucleotides, nucleic acids, peptides, cofactors, lectins, sugars, polysaccharides, cells, cellular membranes, and organelles. Targets are sometimes referred to in the art as anti-probes. As the term targets is used herein, no difference in meaning is intended. A “Probe Target Pair” is formed when two macromolecules have combined through molecular recognition to form a complex.

C. Polymer Surfaces for In Situ Polymer Synthesis of Polymer

In accordance with an aspect of the present invention, a three dimensional polymer matrix or film is provided on a glass slide. An object of the present invention, is to provide a film having a controlled thickness, hydroxyl density and pore size. As microarrays have developed over the last several years, the density of the arrays have increased, i.e., the number of probes (e.g., oligonucleotides attached to the surface) directed to different genes or different parts of genes (either genomic DNA or RNA) per square cm has increased. In 1994, feature size was on the order of 100 μm and the GeneChip arrays had about 16,000 features per chip. In 2002, feature size was down to 18 μm and there were some 500,000 features per chip. These developments have continued with increasing density and more genetic information on the chip.

As feature size shrinks still more, a greater emphasis is put on amplification of the signal. A 5 micron feature has far fewer probes than a 100 micron feature. One method of detecting hybridization to a nucleic acid array is to use probes bearing biotin labeled nucleic acids. Biotin in turn is detected with Streptavidin-Phycoerythin complexes having fluorescent moieties. As the number of probes in the feature decrease, signal from the feature decreases as well.

Thus, in accordance with an aspect of the present invention, three dimensional features are presented. Three dimensional features in accordance with the present invention will allow for features having a small area, but with a higher number of useable probes within the three dimensions. This in turn will allow for generation of a higher signal than the corresponding two dimensional feature of the same area.

The three dimensional coatings of the instant invention, while suited for the photolithographic approach to array fabrication as employed in Affymetrix GeneChip® arrays are in no way limited in their usefulness or applicability to photolithography or nucleic acid arrays. Unless otherwise noted, the claimed methods and compositions are applicable to formation of arrays with other polymers including proteins and peptides and other methods of fabrication including, without limitation, spotting, printing, the use of beads, etc. The reason for this is simple. The three dimensional coatings or the present invention are designed to alleviate issues associated with very high density arrays. These issues cut across the many disciplines and technologies, including polymers, proteins and nucleic acids.

### EXAMPLE 1

### Direct Photopolymerization, Crosslinking and Surface Attachment of Hydrogel Thin Films Containing Poly(vinylpyrrolidone)

It has been reported that crosslinked hydrogels for biomedical applications made from synthetic polymers have been produced by UV photocrosslinking of poly(vinylpyrrolidone) (PVP) using 254 nm from a low pressure Hg lamp (Catalani, L. H.; et al. Polymer 2003, 44, 6217-6222; ). Similar coatings comprising a crosslinked PVP or co-polymer containing N-vinylpyrrolidone have been photo cross-linked to a surface providing hydrophilic coatings with high abrasive resistance (Madsen, N. J. WO 98/58990). In another case coatings comprising PVP as a film-former and polyacrylamide and a co-monomer were prepared by photopolymerization (Feucht, Hans-Dieter WO 2004/020659 A1).

Structures

| 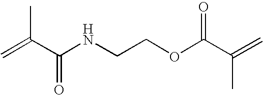 | N-(2-methacryloxyethyl)methacrylamide |
|---|---|
| 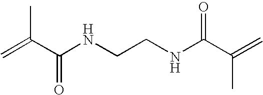 | bis-ethyleneacrylamide |
| 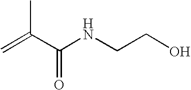 | N-2-hydroxyethylmethacrylamide |
| 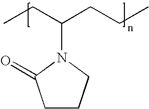 | poly(vinylpyrrolidone) |
| 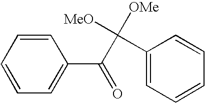 | 2,2-dimethoxy-2-phenylacetophenone |
| HO(CH2CH2O)ₙCH2CH2OH | polyethyleneoxide (average molecular weight |
| | 300) |

In accordance with an aspect of the present invention, formulations comprising one or more of the above structures have been used to form thin, transparent, hard and stable hydrogel films on the surface of glass. The formulations include a film former (PVP), a crosslinker (bis-ethyleneacrylamide or N-(2-ethacryloxyethyl)methacrylamide), a photoinitiator, and optionally a co-monomer and a film softener (PEG).

The following formulations and procedure were used to prepare a 0.75 μm-1 μm thick hydrogel films with high hydroxyl density suitable for the photo-lithographic based synthesis of DNA microarrays:

Formulation 1

10% PVP (mw 10,000)
20% N-(2-methacryloxyethyl)methacrylamide
2% DMPA
10% PEG (300)
Ethyl lactate as solvent
   Formulation 2
10% -20% PVP (mw 40,000)
2% 2-hydroxyethylacrylamide (Duramide)
4% bis-ethyleneacrylamide
2% DMPA
Ethyl lactate as solvent
   Preparation of Coated Glass Slides

A solution of the formulation was purged with argon for 5 minutes. Then 0.5 ml of the solution was spin-coated (3000 RPM, 60 seconds) onto a 2×3 inch glass slide, functionalized with either N-acryloxypropyltrimethoxysilane or a 3-acrylamidopropyltrimethoxysilane. The glass slide was then placed in a UV box and irradiated with 254 nm light for 10 min. (approx. 1 joule). The slide was soaked in a bath of ethyl lactate with gentle swirling for 16 hrs, water for 2 hrs and rinsed with dry acetonitrile and then air dried. The slides were stored in open air.

Film Thickness

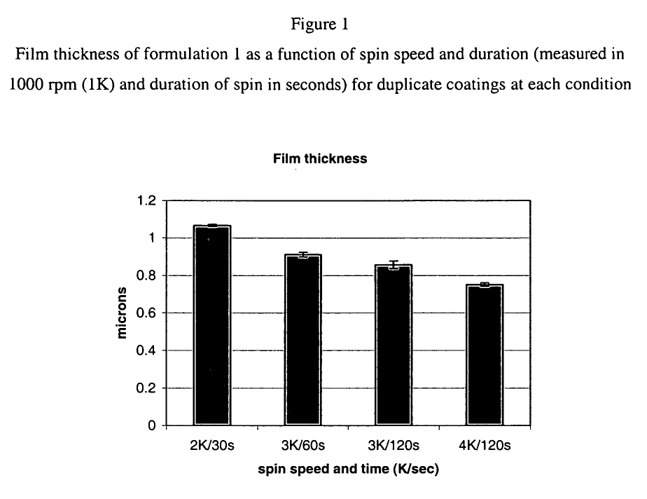

The thickness of the film, determined by a profilometer, ranged from 1.1 μm to 750 nm and was controlled accurately by the spin speed and duration of spin (FIG. 1).

Hydroxyl Density Measurement by HPLC

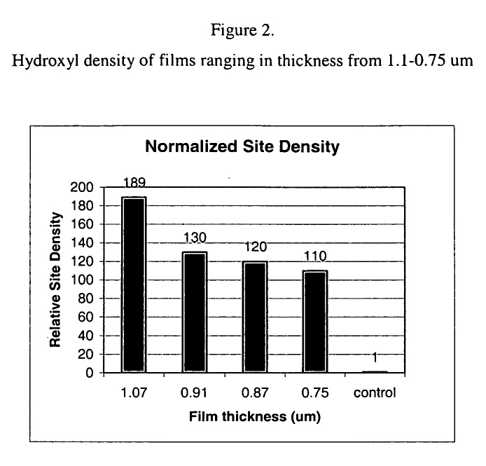

The hydroxyl density was measured by an HPLC-based C3-spacer fluorescein assay according to the procedure of Frank, C., et al. Chem. Mater. 2001, 13, 4743-4782. The site density represents the number of available hydroxyls for oligonucleotide probe synthesis. The values were normalized relative to the density of a control slide in which a piece of flat glass was treated with N-bis-(2-hydroxyethyl)aminopropyl triethoxysilane (Frank, C.; et al. Chem. Mater. 2001, 13, 4743-4782 and references cited therein). The flat control surface is known to give essentially a monolayer of OH sites of about 120 pmols/cm²). The OH density of the hydrogel films was dependent on the thickness of the film and ranged from about 100- to 200-fold that of the density on the control slide (FIG. 2).

Film Stability

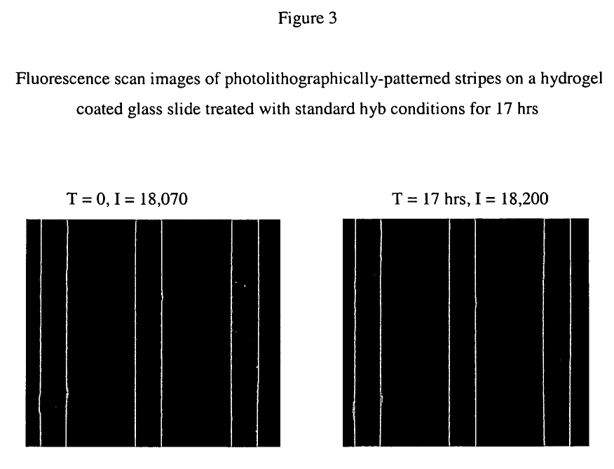

The surface stability was determined by a fluorescence stain assay of photolithographically pattered stripes (Frank, C., et al. Chem. Mater. 2001, 13, 4743-4782). The image and fluorescence signal (I, 488 nm excitation, 520 nm emission) was measured by confocal microscopy at time=0 and then the glass slide was placed in a bath of standard MES hybridization solution at 45° C. for 17 hrs followed by re-scanning. The images in FIG. 3 show that the intensity remains constant and uniform and there was no mechanical disturbance of the film.

HPLC Analysis of Probe Synthesis and Efficiency

To test the efficiency of probe synthesis a homopolymer 6-mer probe was synthesized photolithographically on a 0.75 um thick film of the hydrogel from formulation 2 using MeNPOC-protected thymidine phosphoramidite, a spacer amidite, a fluorescein amidite and a cleavable linker amidite (Frank, C.; et al. Chem. Mater. 2001, 13, 4743-4782 and references cited therein). The control T6-mer was made in the identical manner on a glass slide derivatized with N-bis-(2-hydroxyethyl)aminopropyl triethoxysilane and the cleaved oligonucleotides which are fluorescently labeled at the 3′-end were then analyzed by ion-exchange HPLC. The yield of the 6-mer from the synthesis on the hydrogel film was 42% more efficient than that on control glass.

Hybridization of Oligonucleotide Target

A checkerboard pattern of a 20-mer sequence was photolithographically patterned on the hydrogel-coated surface and hybridized with complimentary fluorescein-labeled 20-mer target sequence under standard conditions (MES buffer, 45° C., 17 hrs). The signal intensity of the synthesis probe area was about 4-fold higher than background (non-synthesis dark region), indicating a measurable hybridization signal. The auto fluorescence of the film was determined by fluorescence scanning (488 nm excitation, emission 520 nm) prior to photopolymerization of the film, after polymerization and post-oligonucleotide synthesis. A considerable amount of autofluorescence in the synthesis regions was observed (˜5-10% of the total hyb signal). This could be due to many factors which will be addressed as development continues.

### EXAMPLE 2

### Hydrogel Immobilization on Glass of a Polymer Composition Comprising Pol[2-hydroxyethylacrylamide-co-acrylamide-co-N-(3-(chloroacetaminopropyl)methacrylamide)]

Polyacrylamide-based media have been developed particularly for the electrophoretic separation of biopolymers (proteins and DNA). One such approach (Eikenberry, J,N; WO 90/12820) utilizes poly(acrylamide-co-N-(3-chloroacetamidopropyl)methacrylamide) which was found to be well suited for producing and controlling a wide range of polymer concentrations and, therefore, a wide range of pore sizes. Creating a large pore size (400 nm) is paramount for applications in hybridization of target DNA sequences to DNA arrays synthesized in such a 3-dimentional matrix.

Structures

| | |
|---|---|
| 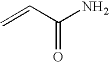 | Acrylamide |
| 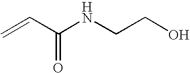 | 2-hydroxyethylacrylamide |
| 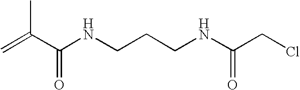 | N-(3-chloroacrylamidopropyl)methacrylamide |
| 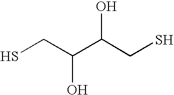 | 1,4-Dithiothreitol |

Hydrogels comprising [2-hydroxyethylacrylamide-co-acrylamide-co-N-(3-(chloroacetaminopropyl)methacrylamide)] were prepared according to the procedures of Eikenberry, J. N., et al. WO 90/12820 and were spin-coated or dip-coated onto the surface of a glass slide derivitized with 3-mercaptopropyl triethoxysilane. Below is a scheme showing the polymer immobilized by a crosslinking reaction of the free thiol group on the glass surface with the chloroacetamido functional group in the bulk polymer layer.

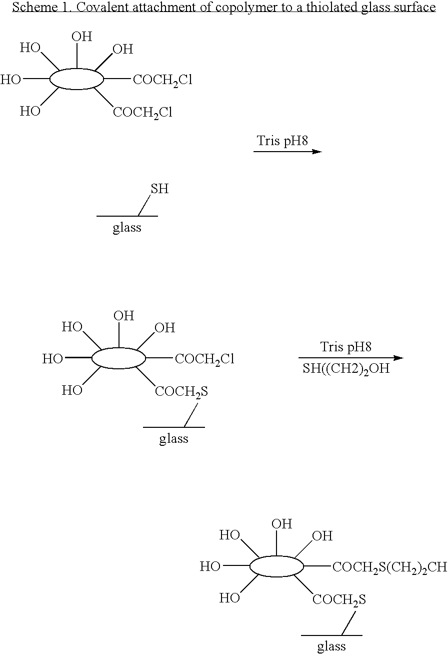

### Synthesis of Poly[2-hydroxyethylacrylamide-co-acrylamide-co-N-(3-(chloroacetaminopropyl)methacrylamide)]

The preparation of this polymer followed the procedure of Eikenberry, J. N., et al. WO 90/12820 in alcohol/water mixtures using the following monomer molar ratios of N-(3-chloroacetaminopropyl) methacrylamide to 2-hydroxyethylacrylamide to acrylamide, 2:10:88 and 10:10:80. Other compositions could be prepared by altering the molar proportion of 2-hydroxyethylacrylamide, acrylamide and N-(3-(chloroacetaminopropyl)methacrylamide. In this way two different crosslinker compositions were tested. The actual composition of the polymers was determined by elemental analysis, as shown in Table 1, and there was found to be about 6% and 21% crosslinker present, respectively.

TABLE 1
Elemental analysis data for poly[2-hydroxyethylacrylamide-
co-acrylamide-co-(3-chloroacetamidopropyl)methacrylamide
made by 2% and 10% seed concentrations of crosslinker

| | composition of polymer | | | | |
|---|---|---|---|---|---|
| | (theor./found) | | | | % crosslinker |
| crosslinker concentration | C % | H % | N % | Cl % | in polymer |
| 2% molar crosslinker | 50.76 | 7.16 | 18.84 | 0.35 | 2% theor. |
| | 48.57 | 7.98 | 15.13 | 1.14 | 6% found |
| 10% molar crosslinker | 50.7 | 7.15 | 17.81 | 1.62 | 10% theor. |
| | 45.82 | 7.95 | 12.77 | 3.42 | 21% found |

Crosslinking in Solution

The crosslinking reaction was tested by mixing an aqueous solution of the copolymer (10% w/w) in 20 mM Tris pH 8 buffer with 1 equivalent of DTT and observing if gelation takes place. In both compositions gel formation was observed. Procedure for coating and immobilization of copolymer as a monolayer on a thiol surface The glass surface (2×3 inch slide) was derivatized with 3-mercaptopropyl triethoxysilane according to standard procedures. The glass slide was then dip-coated into a solution of 20% (w/w) of copolymer in 10 mM Tris pH 8. The slides were allowed to stand under argon for 24 hrs and then washed with water and then treated with a solution of 50 mM mercaptoethanol in 10 mM Tris pH 8. This was to quench any remaining chloroacetoamido groups, effectively converting electrophilic chloroacetamido groups to OH groups. After quenching, the slides were rinsed with water and then sonicated in water for a few minites, rinsed with acetonitrile and air dried. A thin, transparent, hydrophilic film remained as judged by contact angle measurements of the coated and uncoated regions.

Hydroxyl Density

HPLC-based OH density experiments previously described in Example 1 indicated that the density was equivalent to that of the control slides (bis-2-(hydroxyethyl)aminopropyl silane surface) and, therefore, a monolayer of polymer was immobilized under these conditions (FIG. 2).

Oligonucleotide Synthesis Efficiency

In a similar way as in Example 1, the synthesis efficiency of probes was tested by photolithographically synthesizing fluorescein-labeled T6-mers and analyzing the cleaved oligos by HPLC analysis. Again, the synthesis efficiency of the hydrogel film was about 30% more efficient than that of the control.

Procedure for Grafting Bulk Polymer (Scheme 2)

The procedure for formation of an immobilized monolayer of copolymer was followed as above with the exception that the film was quenched with a solution of 50 mM DTT in Tris pH 8 buffer. This converted any remaining chloroacetoamido groups to SH groups. Then the slides were again dip coated (spin-coated) into a solution of 20% (w/w) of copolymer in 10 mM Tris pH 8 containing 1 equivalent of DTT. The slides were then incubated and washed as previously. Stability tests of the resultant film indicated some mechanical instability of the film (cracking and pealing), therefore, additional optimization for proper stability continues.

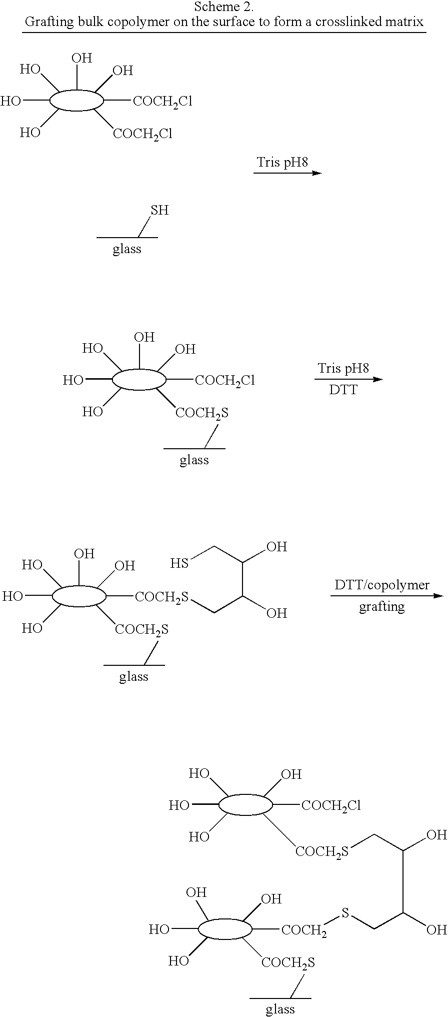

It is to be understood that the above description is intended to be illustrative and not restrictive. Many variations of the invention will be apparent to those of skill in the art upon reviewing the above description. All cited references, including patent and non-patent literature, are incorporated herein by reference in their entireties for all purposes.

What is claimed is:

1. A method for preparing a hydrophilic polymer coating possessing a high degree of hydroxyl groups to a substrate surface to produce a hydrogel, having a pore size, said method comprising the steps of
coating a solution of a mixture of a poly(vinylpyrrolidone), a copolymer containing an N-vinylpyrrolidone, a photoinitiator, and a crosslinker,
photopolymerizing said mixture; and
crosslinking and covalently attaching said mixture to a substrate surface using light of about 250 nm.

2. A method according to claim 1 wherein said step of coating is spin coating.

3. A method according to claim 1 wherein said step of coating is dip coating.

4. A method according to claim 1 wherein said mixture additionally comprises a co-monomer.

5. A method according to claim 1 wherein said mixture additionally comprises a film softener.

6. A method according to claim 1 wherein hydrophilic polymer has a molecular weight range of about 5000-100,000.

7. A method according to claim 1 wherein said hydrophilic polymer is characterized in that the copolymer of N-vinylpyrrolidone contains a hydrophilic polymer selected from the group consisting of polysaccharides, poly(meth)acrylic acid, polyethylene glycols (PEG), poly (meth)acrylic amides, and polyvinyl alcohols.

8. A method according to claim 4 wherein said co-monomer is a hydrophilic monomer to produce a hydrophilic coating.

9. A method according to claim 4 wherein said hydrophilic monomer is selected from the group consisting of (meth)acrylic acid, (meth)acrylic amides, and vinyl alcohols.

10. A method according to claim 1 wherein the photoinitiator is 2,2-dimethoxy-2-phenylacetophenone.

11. A method according to claim 1 wherein the photo crosslinker is selected from the group consisting of N-(2-methacryloxyethyl) methacrylamide and bis-ethyleneacrylamide.

12. A method according to claim 5 wherein said film softener is polyethylene glycol.

13. A method according to claim 1 wherein said substrate surface further comprises a coating with a polymer containing a photopolymerizable moiety.

14. A method according to claim 13 wherein said polymer is selected from the group consisting of an acrylate and an acrylamide.

15. A method according to claim 8, characterized in that the substrate surface is glass and said hydrophilic coating is selected from the group consisting of 3-acryloxypropyl trimethoxysilane or a 3-acrylamidopropyl trimethoxysilane.

16. Specifically the hydrophilic coating in claim 9 resulting from the formulation: 10% PVP (mw 10,000), 20% N-(2-methacryloxyethyl)methacrylamide, 2% DMPA, 10% PEG (300), and ethyl lactate as solvent.

17. A method according to claim 8 where in said hydrophilic coating results from the formulation: 20% PVP (mw 40,000), 2% 2-hydroxyethylacrylamide (Duramide), 4% bis-ethyleneacrylamide, 2% DMPA, and ethyl lactate as solvent.

18. A method according to claim 8 for preparing a hydrophilic polymer coating possessing a high degree of hydroxyl groups on a substrate surface by spin coating or dip coating a solution of a hydrogel comprising a copolymer containing acrylamide, acrylamides possessing hydroxyl groups and acrylamides possessing electrophilic groups onto a substrate surface derivatized with nucleophilic groups.

19. A method according to claim 1 wherein the hydrogel is a co-polymer comprising [2-hydroxyethylacrylamide-co-acrylamide-co-N-(3-(chloroacetaminopropyl)methacrylamide)] containing greater than or equal to 6% molar chloroacetamido groups.

20. The method of claim 13 in which the substrate is glass coated with a polymer containing a thiol group like 3-mercaptopropyl triethoxysilane.

21. A method according to claim 1 wherein the hydrogel is crosslinked to the thiol surface by incubation of the hydrogel coated glass in Tris pH 8 buffer to form a stable coating covalently attached to the silane surface.

22. A method according to claim 1 in which the immobilized hydrogel can be crosslinked by treatment of the layer with DTT to form large pore sizes.

23. A method according to claim 1 in which the film can be thickened by grafting additional layers of hydrogel onto the hydrogel film and crosslinking by treatment with DTT.
